(19) United States
(12) Patent Application Publication
(10) Pub. No.: US 2011/0090063 A1
(43) Pub. Date: Apr. 21, 2011

(54) APPARATUS AND METHOD USING HISTOGRAM-BASED TECHNIQUES FOR AVOIDING OVERPOLLING

(76) Inventors: DAVID BRUCE KOONS, San Jose, CA (US); Miroslav Zmrzli, San Francisco, CA (US)

(21) Appl. No.: 12/908,641

(22) Filed: Oct. 20, 2010

Related U.S. Application Data
(60) Provisional application No. 61/253,722, filed on Oct. 21, 2009.

(51) Int. Cl. H04Q 5/22

(52) U.S. Cl. 340/10.33

(57) ABSTRACT

A device including an RF transceiver coupled to receive signals from an antenna; and a micro-controller coupled to the RF transceiver periodically scanning for a wakeup signal and measuring a signal strength is provided. The micro-controller may use the signal strength to update a count value in a bin of a histogram. The micro-controller may also decrement histogram values periodically, and direct the RF transceiver to respond to the wakeup signal if the count value in the histogram is lower than a threshold value. Further according to some embodiments disclosed herein a system for avoiding over polling in wireless communications may include a tag and a reader. The reader may transmit a wakeup signal periodically and the tag may operate as the device disclosed above. Also, a method for using a device and a system as above is provided.

### CROSS-REFERENCE TO RELATED APPLICATIONS

This application relates, and claims priority, to U.S. Provisional Patent Application No. 61/253,722 filed Oct. 21, 2009, the disclosure of which is incorporated by reference, in its entirety here for all purposes.

### BACKGROUND

1. Field of the Invention

The embodiments described herein relate to the field of over polling protection methods in Radio-Frequency Identification (RFID) or other similar systems.

2. Description of Related Art

RFID tags (including certain tags manufactured by Savi Technology Inc. of Mountain View, Calif.) spend much of their lifetime in a low-power mode that includes polling for the presence of a “wakeup” signal from a nearby interrogator. Every pre-selected period of time, for example 2.3 seconds, a tag will wake from a ‘sleep’ mode for a very short time (such as 2 milliseconds) to turn on a receiver included in the tag and search for the presence of a wakeup signal. The receiver may be part of a radiofrequency (RF) transceiver, such as an Ultra-High Frequency (UHF) transceiver. If no wakeup signal is detected, the tag will shut down the receiver and set up a timer to wake up for the next poll after a pre-selected period of time, for example 2.3 seconds. The tag then re-enters a ‘sleep,’ or power-saving, mode. When a tag detects a wakeup signal it will enter an active mode that leaves the RF receiver ‘on,’ listening for any incoming commands for a wake up period that may last as long as 30 seconds or more.

When a reader wishes to begin communication with tags that are within listening range it will transmit a wakeup signal for a pre-selected period of time, for example 2.4 to 4.8 seconds. Tags that detect a valid wakeup signal will switch to active mode and await commands from the reader. In some installations, readers may be configured to frequently repeat the wakeup/command cycle to maintain coverage when assets and tags are rapidly moving in and out of an area. A tag that remains close to such a “fast-polling” reader will react to each wakeup/command cycle and will quickly consume its battery capacity.

What is needed are better responses in order to preserve the limited power resource of the tags.

### SUMMARY

According to some embodiments disclosed herein a device including an RF transceiver coupled to receive signals from an antenna; and a micro-controller coupled to the RF transceiver periodically scanning for a wakeup signal and measuring a signal strength, is provided. The micro-controller may use the signal strength to update a count value in a bin of a histogram. The micro-controller may also decrement histogram values periodically, and direct the RF transceiver to respond to the wakeup signal if the count value in the histogram is lower than a threshold value.

Further according to some embodiments disclosed herein a system for avoiding over polling in wireless communications may include a tag and a reader. The reader may transmit a wakeup signal periodically and the tag may receive the wakeup signal from the reader and measure the signal strength. The system may use the signal strength to update a count value in a bin of a histogram. The histogram values may be decremented periodically; and the tag may respond to the wakeup signal if the count value in the histogram is lower than a threshold value.

Further according to some embodiments disclosed herein, a method for using a device may include the steps of receiving a wakeup signal using an RF transceiver and measuring the signal strength using a micro-controller. Further, the method may include the steps of using the signal strength to update a count value in a bin of a histogram and decrementing the histogram values periodically. Thus, a step of responding to the wakeup signal from the reader using the RF transceiver may be performed if the count value in the histogram is lower than a threshold value.

Further according to some embodiments disclosed herein, a method for avoiding over polling in wireless communications between a tag and a reader may include the steps of sending wakeup signals periodically using the reader, and receiving the wakeup signal from the reader using the tag. The method may include the steps of measuring a signal strength using the tag and using the signal strength to update a count value in a bin of a histogram. Further, the step of decrementing the histogram values periodically may be included. Thus, a step of responding to the wakeup signal from the reader using the tag may be performed if the count value in the histogram is lower than a threshold value.

These and other embodiments will be described in further detail below, with reference to the following drawings.

### BRIEF DESCRIPTION OF THE FIGURES

FIG. 1A illustrates a block diagram depicting a radio-frequency identification (RFID) tag according to some embodiments.

FIG. 1B illustrates a block diagram depicting a radio-frequency identification (RFID) reader according to some embodiments.

FIG. 2 illustrates a timing diagram showing a timing configuration for a reader and a timing configuration for a tag according to some embodiments.

FIG. 3 illustrates a histogram of Received Signal Strength Indicator (RSSI) data having an RSSI depth and a threshold, according to some embodiments.

FIG. 4 is a flow chart illustrating the steps for a method to avoid over polling according to some embodiments.

Wherever possible, the same reference numbers are used throughout the drawings to refer to the same or like elements.

### DETAILED DESCRIPTION OF THE FIGURES

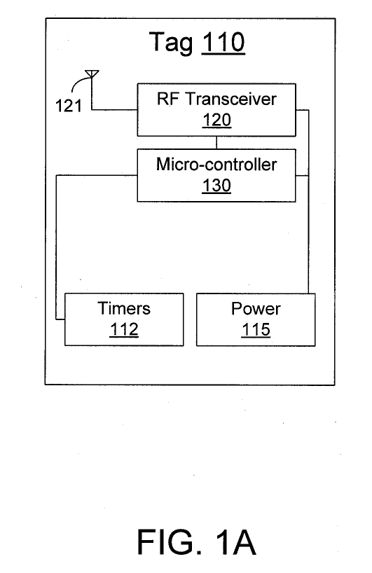

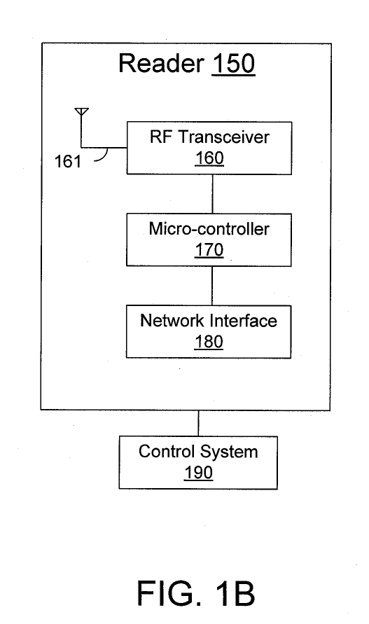

FIG. 1A is a block diagram depicting RFID tag 110 according to some embodiments. FIG. 1B is a block diagram depicting RFID reader 150 according to some embodiments. Reader 150 may be stationary in a central location of a storage facility, or may be portable. Tag 110 may be one of a plurality of tags, reader 150 and tags 110 forming a network or set. Each tag 110 may be attached to a particular component or a piece of merchandise. Tag 110 may contain specific information related to the component or merchandise that it is attached to. In some embodiments, tag 110 may be carried by a person, and contain information related to that person.

As shown in FIG. 1A, the RF signals transmitted by reader 150 may be received in tag 110 by an RF transceiver 120 using antenna 121. Tag 110 may also include micro-controller circuit 130, timers 112, and a power circuit 115, according to some embodiments. RF transceiver 120 may be a UHF transceiver in some embodiments. In a manner similar to controller 170 for reader 150, controller 130 for tag 110 may include processor and memory circuits. In some embodiments, controller 130 may thus receive commands from reader 150 and provide responses to the commands through transceiver 120. In some embodiments controller 130 may include a programmable gain amplifier circuit to measure the received signal strength from reader 150. In some embodiments, controller 130 may include other power measurement circuits to obtain a received signal strength indicator (RSSI). Timers 112 in tag 110 provide timing signals to controller 130 in order to determine whether or not an RSSI value may be measured.

Timers 112 provide timing signals to power management circuit 115 to provide a turn ‘on’ power to transceiver 120 and controller 130. Timers 112 may also provide a signal to transceiver 120 to turn ‘on’ and look for a wakeup signal provided by reader 150, according to some embodiments. Thus, timers 112 may be programmed to provide a ‘turn on’ signal to transceiver 150 at SSP intervals of time.

Power circuit 115 provides operating voltage and current to transceiver 120, controller 130, and receiver 140. Power circuit 115 may include a battery such as a lithium ion battery. The battery included in circuit 115 may be a regular, off-the shelf battery. In some embodiments, the battery in circuit 115 may be a rechargeable battery.

As shown in FIG. 1B, reader 150 may include radiofrequency (RF) transceiver 160, an antenna 161, a micro-controller 170, and a network interface 180. Reader 150 may transmit and receive RF signals using antenna 161. In some embodiments, RF transceiver 160 may be a UHF transceiver. Controller 170 may include circuits such as processors and memories (not shown in FIG. 1) to allow reader 150 to process data and information received from tag 110 via transceiver 160. In some embodiments, controller 170 may also provide commands to tag 110 through transceiver 160 that request information and updates from tag 110. In some embodiments reader 150 may include network interface 180 to communicate with control system 190 outside of reader 150. Control system 190 may communicate with reader 150 through a network using an Ethernet connection or a wireless connection. Control system 190 may also communicate with a plurality of readers 150 through the same network.

One common technique for polling tag 110 is to have reader 150 transmit a wireless “wakeup” signal periodically. The period for the “wakeup” transmission by the reader may vary depending on the application. In some embodiments the “wakeup” transmission may be sent every 30 seconds, for example. Some embodiments may have readers transmitting “wakeup” signals with other time periods. In some embodiments, the wakeup signal may direct receiving tags to transmit a wireless reply in order to identify themselves to the reader. Tag 110 may operate on a battery included in power circuit 115. To preserve battery power in circuit 115, tag 110 may have multiple operating modes, including a normal operation mode and a “sleep” or “rest” mode. In the sleep mode a low power is consumed because most but not all of the tag's circuitry is powered down in order to reduce battery drainage. Tag 110 may remain in the sleep mode for a substantial amount of time. In some embodiments, tag 110 may switch from a sleep mode to a normal operation mode in pre-selected time intervals. Some embodiments may turn ‘on’ to normal mode every few seconds during their ‘sleep’ mode of operation. For example, tag 110 may turn ‘on’ to normal operation every 2.3 seconds.

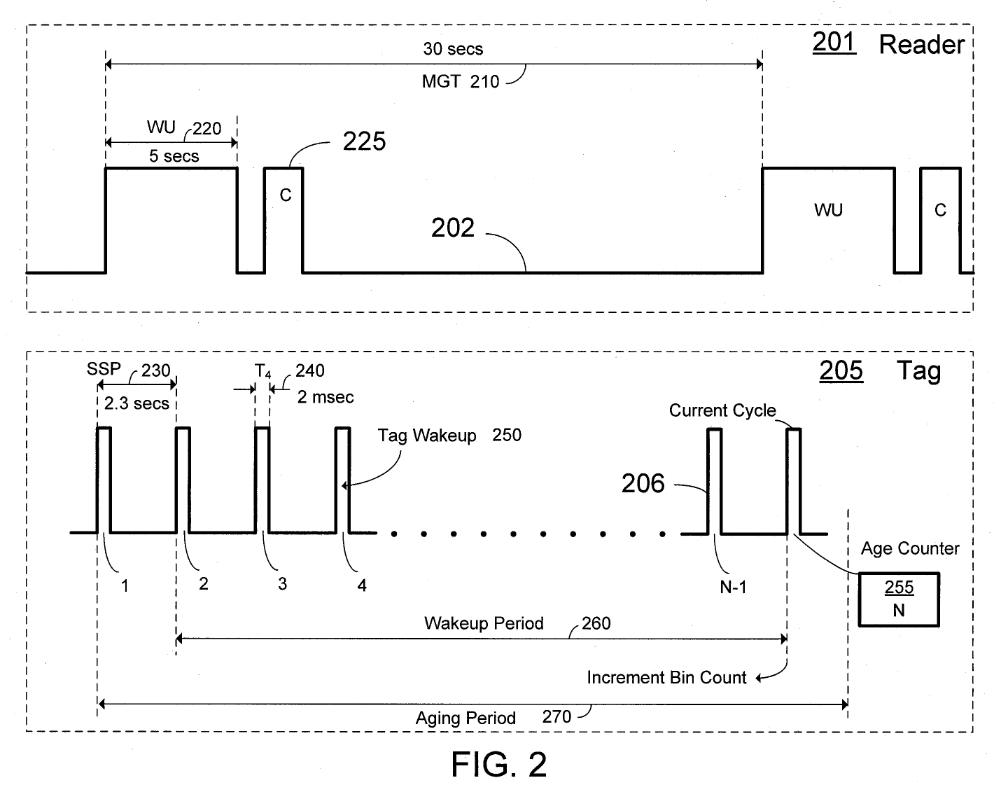

FIG. 2 shows a timing diagram illustrating timing configuration 201 for reader 150 and timing configuration 205 for tag 110. Timing 201 may include signal 202 from reader 150 and timing 205 may include signal 206 in tag 110, according to some embodiments. The pre-selected time intervals during which tag 110 remains in sleep mode may be called sleep-scan periods (SSP) 230. During an SSP 230 tag 110 may remain in normal mode of operation for a pre-selected period of time, usually much shorter than the time interval during which tag 110 is in ‘sleep’ mode. In some embodiments, the time during which tag 110 is turned ‘on’ may be a few milliseconds, such as two (2) milliseconds. While tag 110 is ‘on,’ it may be checking for the presence of wakeup signal (WU) 220 from reader 150. If no wakeup signal is detected, tag 110 may return to its ‘sleep’ mode of operation after the pre-selected period of time (a few milliseconds). If WU 220 signal is detected, tag 110 may remain in the normal operational mode for a longer period of time in order to receive a command from reader 150, and then transmit a reply back to the reader. For example, if a wakeup signal is detected, tag 110 may remain ‘on’ for a period of about 30 seconds or more, waiting to receive an entire command or message from reader 150, and transmitting a response back to reader 150. In some embodiments, the period of time during which the tag remains ‘on’ after detecting a wakeup signal may be the Maximum Guard Time (MGT) 210.

Timing configuration 201 for reader 150 may include wakeup period (WU) 220 and MGT period 210. In some embodiments consistent with FIG. 2, WU 220 may be 5 seconds and MGT 210 may be much longer, such as 30 seconds. During WU 220, transceiver 160 may continuously broadcast a wakeup signal to its surroundings. In some embodiments consistent with FIG. 2, signal 202 may include portion 225 transmitted after WU 220. Portion 225 may be referred to as a “Collect” portion C, and may contain information about reader 150. For example, a power level indicator for the signal emitted by reader 150 may be included in C 225. This information may be codified digitally as a bit string, to be used by tag 110 in order to obtain a Received Signal Strength Indicator (RSSI). The signal in WU 220 may be a 31.25 kHz tone lasting 5 seconds. This is one industry standard, but according to other ISO standards WU 220 may have any one of a range of values from 2.4 to 4.8 seconds. Some embodiments may be compatible with all these standards, such as the ISO 18000-7 standards, including the ISO/IEC-7:2009 standards.

Portion C 225 may contain a reader identification code (RID) and a command (CMD). The RID is a code uniquely identifying reader 150 transmitting signal 202. Command CMD may be any one of a number of commands that reader 150 can send to tag 110. For example, CMD may be a “collect” command instructing tag 110 to send an identification signal back to reader 150. The response from tag 110 may include information about the asset associated with tag 110, be it a piece of merchandise or a person.

Timing configuration 205 may include timing signal 206. Signal 206 may be provided to tag 110 by timers 112 (cf. FIG. 1). Signal 206 may include SSP 230, which as mentioned above is a time interval between the start of two consecutive ‘turn on’ intervals T₄ 240, in tag 110. The ‘turn on’ signal may be provided by tag wakeup pulse 250 to power ‘on’ transceiver 120 in tag 110. According to embodiments consistent with FIG. 2, SSP 230 may be 2.3 seconds. In embodiments consistent with FIG. 2, most of SSP 230 is spent with tag 110 in a ‘sleep’ mode. SSP 230 may also include interval T₄ 240 during which tag 110 is turned ‘on’ to look for WU 220 provided by reader 150. T₄ 240 may be much shorter than SSP 230, such as a few milliseconds. For example, while SSP 230 may be 2.3 seconds, T₄ 240 may only be 2 milliseconds. Timing configuration 205 may also include age counter 255, wakeup period 260, and aging period 270.

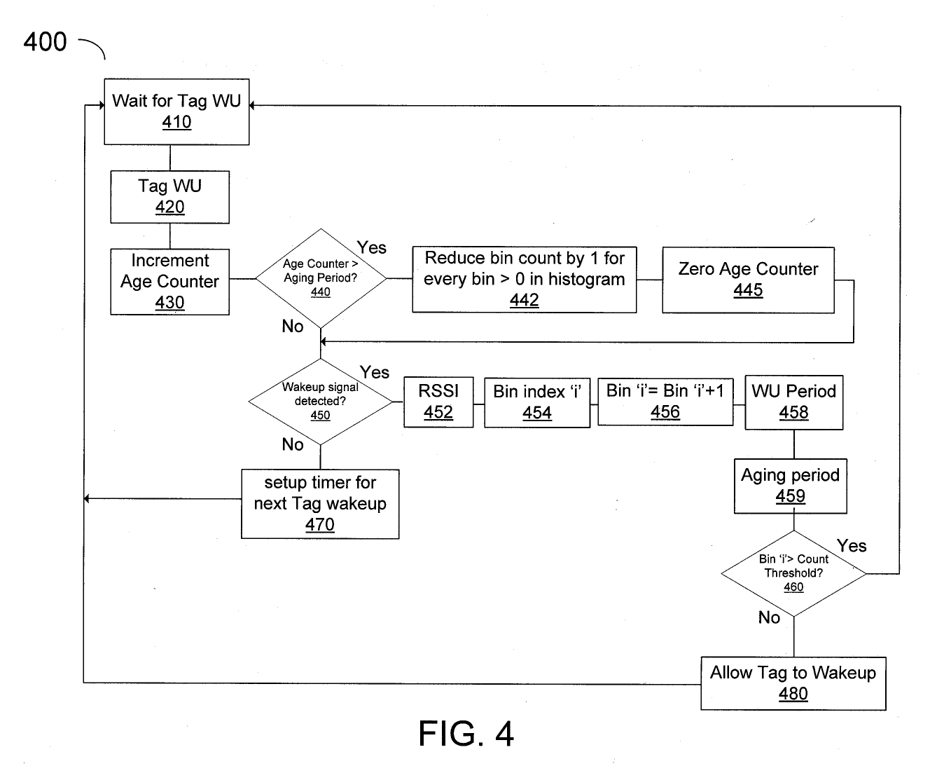

Wakeup period 260 may be obtained by tag 110 using controller 130 and timers 112, according to some embodiments consistent with FIG. 2. Period 260 may be the time period between the detection by tag 110 of two successive WU signals 220 from reader 150. For example, in the embodiment illustrated in FIG. 2 period 260 may be the time interval between pulse 250 no. 2 and pulse 250 no. ‘N.’ Period 260 may be measured in time units (seconds or clock cycles), or in integers representing the number of SSP cycles 230 included between detection of two successive WU signals from reader 150. Aging period 270 may be set by controller 130 and used according to steps that will be described in relation to FIG. 4, below. Period 270 may begin with detection of WU 220 from reader 150 during a first pulse 250. Aging period may be provided as an integer number ‘N,’ related to the number of pulses 250 included in a pre-selected period of time. Age counter 255 may be started once a first pulse 250 detects WU 220 from reader 150. Counter 255 keeps track of every pulse 250 until aging period 270 is reached. While period 260 may be related to MGT 210 in reader 150, they may not be the same. Note that in FIG. 2 wakeup period 260 starts with pulse 250 no. 2 because this is the last pulse 250 within the WU 220 signal prior to pulse 250 N.

According to some embodiments consistent with FIG. 2, period 260 may be shorter than period 270. For example, period 270 may be long enough to include a plurality of periods 260. In some embodiments, period 260 may be longer than period 270. In some embodiments period 270 may be obtained by controller 130 in tag 110 from the measured value of period 260. In some embodiments consistent with FIG. 2, an integer value C may be provided as a threshold such that at least a number of ‘K’ wakeup periods 260 may be included within one aging period 270. The values of period 260, period 270, and threshold K may be continuously updated by tag 110, using controller 130.

During period 260, transceiver 120 in tag 110 may be turned ‘on’ to receive commands from reader 150 and transmit responses to reader 150. Also during period 260, RSSI value 301 may be obtained in tag 110. RSSI 301 may be provided by controller 130, after measuring the power level of the signal detected by transceiver 120. To do this, some embodiments may include an RF power measuring circuit in controller 130, which may use a programmable gain amplifier. In addition to measuring RF power of the received signal, controller 130 may also use a power level indicator contained in portion C 225, as provided by reader 150. The power level indicator provided by reader 150 and the power level measured by tag 110 may be used by controller 130 to obtain RSSI 301 adjusted to the power settings of reader 150. This may account for variations in the power emitted by reader 150, which may be due to power management issues in reader 150 such as battery drainage.

Even though tags may operate in ‘sleep’ mode most of the time, the small periods of time that the tags are turned ‘on’ may add up to a substantial amount over a long period of operation. For example, a tag that remains in a fixed location, may spend a significant amount of time and battery power receiving and responding to numerous wakeup signals from a nearby reader. Thus, a situation may arise where the tag sends redundant information to a reader, wasting time and power. This situation may be referred to as “over polling” and usually results in rapid and inefficient power drainage for the tags. Moreover, over polling may negatively impact the timeliness of responses in a system including a plurality of tags and readers. When a tag is engaged by a reader and turned ‘on,’ then a longer interval may be devoted by the reader to communicate with the tag. This may be a waste of time for the reader if the information has already been provided by the tag and there are other tags that may need to be read, containing new information. Thus, it would be desirable for a tag to be able to ‘disengage’ or ‘block out’ from a given reader, or reading event.

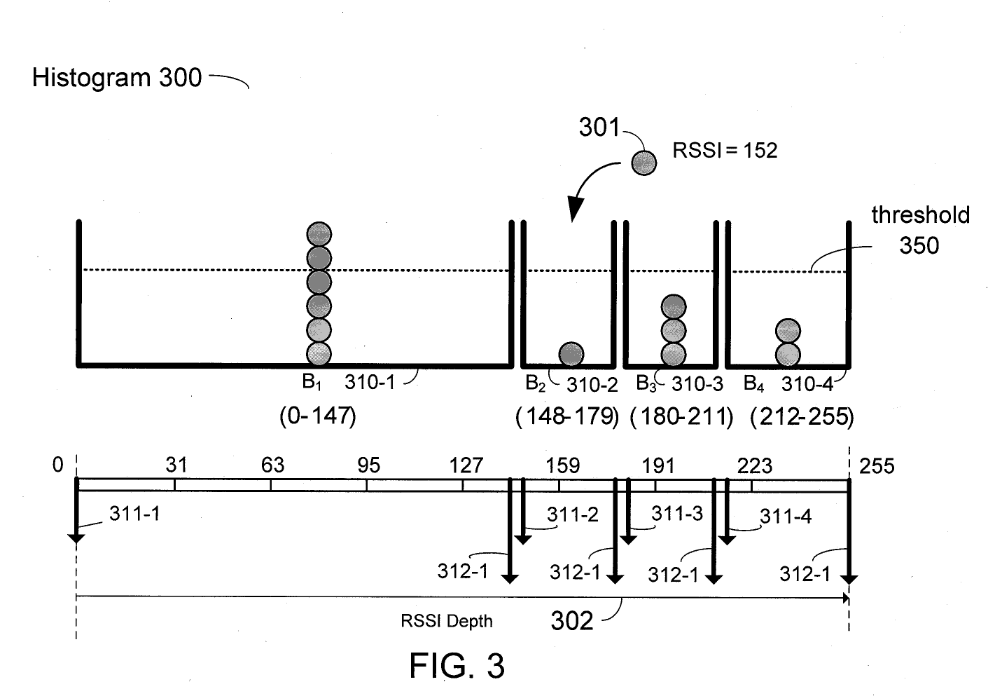

FIG. 3 illustrates histogram 300 of RSSI 301 data having RSSI depth 302 and a threshold 350 (‘K’), according to some embodiments. Each time tag 110 detects a valid wakeup signal from reader 150 the tag can measure the signal strength or Received Signal Strength Indicator (RSSI) value for that signal. RSSI 301 may be related to the RF environment: the relative orientation and distance between reader 150 and tag 110 and objects or surfaces that may block or reflect radio signals. Thus, a tag may identify and categorize multiple readers based on their associated RSSI values. Controller 130 in tag 110 may provide RSSI value 301 to histogram 300, which may be stored in tag 110. RSSI 301 may be provided as a digital bit string, for example 1 byte (8 bits). The size of the bit string defines an RSSI depth 302, as in 2^{L}−1, where ‘L’ is an integer representing the string length (cf. FIG. 3). RSSI depth 302 may be determined by several factors, such as the resolution of the power measurement circuit included in controller 130, and the power level of the signal emitted by reader 150. For a string length of 1 byte, L=8 and RSSI depth 302 may be 2⁸−1=256. Having RSSI 301, histogram 300 may be provided as illustrated in FIG. 3.

According to some of the methods disclosed herein a histogram representation may be used to categorize each detected wakeup signal into a “bucket” or bin based on its measured RSSI value. Each time a wakeup signal is detected by a tag within a bucket's RSSI range the bucket's counter is incremented by one. When a bucket's counter exceeds a parameterized threshold value the tag will begin blocking its reaction to readers with RSSI values within this range.

Histogram 300 is provided by making a partition of RSSI depth 302 into a number of ‘P’ bins, or ‘buckets’ 310-1 to 310-p. In the embodiment depicted in FIG. 3, depth 302 is partitioned into 4 buckets of different size, 310-1 to 310-4. Each bucket 310-i spans an RSSI range given by a lower margin 311-i and an upper margin 312-i. The RSSI range for bucket 310-i is then 312-i minus 311-i. According to the embodiment illustrated in FIG. 3, the range for bucket 310-1 is larger than that of buckets 310-2 to 310-4. As illustrated in FIG. 3, B₁ 310-1 has a range of 0-147; B₂ 310-2 has a range 148-179; B₃ 310-3 has a range 180-211, and B₄ 310-4 has a range 212-255, where the integer value is indicative of the RSSI value. Some embodiments may have a different correlation of bucket ranges used. Histogram 300 is obtained by providing counts to each of buckets 310-i according to the RSSI value 301 generated by tag 110. For example, in the embodiment depicted in FIG. 3 RSSI 301 with a value of 152 will increase the count in bucket 310-2 by one (1), since the value 152 falls within the range 148-179 of bucket 310-2.

According to some embodiments, threshold 350 may be provided to avoid over polling tag 110 by reader 150. Threshold 350 may be an integer value, ‘K’ such that once the counts in any of buckets 310-i surpasses the value of ‘K’ tag 110 is blocked from responding to reader 150 for that polling event. That is, once the count on bucket 310-i reaches threshold 350, ‘K’ if a new wakeup signal having RSSI 301 in the range of bucket 310-i is detected, tag 110 will not ‘turn on’ to communicate with reader 150. The relative sizes of bucket ranges 310-1 to 310-p may prevent over polling under specific circumstances. For example, for embodiments consistent with FIG. 3, having bucket 310-1 considerably larger than buckets 310-2 to 310-4, may have the effect of avoiding over polling tags 110 located farther away from reader 150. According to some embodiments, lower RSSI values 301 may correspond to a tag 110 located farther away from reader 150. Likewise, higher RSSI values may correspond to a tag 110 located closer to reader 150. The relative ranges of buckets 310-1 to 310-p may be changed continuously during the course of operation of reader 150 and tags 110.

In addition, the histogram may be periodically “aged” by decrementing each bucket's counter by one after a pre-selected period of time, or “aging” time. If the buckets are being filled at a rate that is faster than the rate of “aging,” then the bucket will eventually “overflow” and exceed the threshold value. This may be the case for stationary tags located in the vicinity of a reader, or slowly moving through a vicinity of the reader. For example, some tags may move around the vicinity of a reader without leaving an area where they may still respond to a reader poll and produce an “overflow” of a bin in the RSSI histogram. In some embodiments, a stationary or slow moving tag may be in close proximity to a fast-polling reader “overflowing” the tag with polling requests or wakeup commands. If the tag is removed from a fast-polling reader, the corresponding buckets in the RSSI histogram will drain back to a count of zero, or below threshold, by virtue of the decrements introduced after repeated “aging” periods. Thus, the tag may become again responsive to wakeup signals in the range of RSSI values corresponding to the specific bucket that has been “drained” below threshold.

In some embodiments, histogram 300 may be stored in tag 110, so that a decision to not ‘turn on’ tag 110 during WU 220 may be readily made in tag 110 before consuming more power in transceivers 120 and 160. Threshold 350 may be changed during operation of reader 150 and a plurality of tags 110. The values for lower margins 311-i and upper margins 312-i of buckets 310-i may also be changed continuously. In some embodiments, changes to the elements of histogram 300 may be introduced to the system continuously by control system 190 via network interface 180 included in reader 150.

FIG. 4 illustrates flow chart 400 that includes the steps for a method to avoid over polling according to some embodiments. In step 410 tag 110 waits for WU signal 220 from reader. While doing so, every time period 230 tag 110 wakes up from low-power mode and listens for wakeup signal for time period T₄ 240. When wakeup pulse 250 is produced by tag 110 in step 420, age counter 255 is incremented by one (1) in step 430. Counter 255 is compared to aging period 270 in step 440. If counter 255 is greater than period 270 (where period 270 is measured in integer units of period 230), step 442 is performed. In step 442, each bin count in histogram 300 that is different from zero is decremented by one (1). In step 445, counter 255 is set to zero and tag 110 returns to the main sequence to perform step 450.

Step 450 is performed if step 440 returns counter 255 as lower than period 270, or after step 445. In step 450, tag 110 is queried as to whether or not wakeup signal 220 from reader 150 has been detected. If signal 220 is detected, RSSI 301 is obtained by tag 110 in step 452 (RSSI value is measured upon detection of WU 220) and provided to step 454 to determine bin index 310-i. Histogram 300 is updated in step 456. Using counter 255, WU period 260 may be obtained in step 458 as the time elapsed since last valid wakeup signal detection. Period 260 is provided to step 459, where aging period 270 may be calculated based on the value of period 260. In step 460, a determination is made as to whether or not the count in bin 310-i is greater than threshold 350. If it is, then tag 110 is blocked from reacting to reader 150 and is returned to step 410. If it is not, then in step 480 tag 110 is allowed to wakeup and turn ‘on’ RF receiver in transceiver 120 for a period MGT 210. After MTG 210 period has elapsed tag 110 returns to step 410.

If wakeup signal 220 from reader 150 is not detected in step 450, timer 112 in tag 110 is setup for next poll according to time period SSP 230 in step 470. Also in step 470, tag 110 is put back to ‘sleep’ mode and returns to step 410.

From the description of the above embodiments, it may be seen that the choice of aging period 270 and the value of threshold ‘K’ 350 may have complementary effects. For example, a short aging period 270 may allow histogram 300 to be refreshed, allowing tag 110 to respond to polls from reader 150 more frequently. The same effect may be obtained by increasing the value of ‘K’ 350. In some embodiments, a longer value of aging period 270 may allow bins in histogram 300 to reach threshold K 350 more rapidly so that tag 110 may be blocked from responding to reader 150. The same effect may be obtained by reducing the value of threshold K 350.

Some embodiments may add the capability of having more than one threshold K 350. For example, in some embodiments each bin 310-i in histogram 300 may have a specific threshold value Kᵢ 350-i associated with it. Some embodiments may adjust the values of aging period 270 and threshold K 350 so that immediate access by tag 110 to an asynchronous reader 150 may be allowed. One example of such an asynchronous reader may be a handheld reader that may be moving around an area with multiple tags 110. In this situation, tags 110 located farther from the reader may be allowed to establish communication, while closely located targets are most likely related to targets previously recorded by handheld reader 150 and therefore blocked out of communication.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed is:

1. A device comprising:
an RF transceiver coupled to receive signals from an antenna; and
a micro-controller coupled to the RF transceiver periodically scanning for a wakeup signal and measuring a signal strength; wherein
the micro-controller uses the signal strength to update a count value in a bin of a histogram, the micro-controller decrements histogram values periodically, and
directs the RF transceiver to respond to the wakeup signal if the count value in the histogram is lower than a threshold value.

2. The device of claim 1 further comprising:
a timer circuit and a power management circuit to deliver power coupled to the RF transceiver and the micro-controller; and wherein
the micro-controller circuit regulates the power delivered by the power management circuit using the wake-up signal and a signal from the timer circuit.

3. The device of claim 2 wherein the power delivered by the power management circuit is selected from the group consisting of a low power value (sleep power) and a high power value (turn on power).

4. The device of claim 3 wherein the RF transceiver is turned on periodically to look for wakeup signals from the reader;
the RF transceiver is turned on by wakeup pulses provided by the micro-controller; and
the period to turn on the RF transceiver is provided by the timer circuit.

5. The device of claim 3 wherein the power management circuit delivers a turn on power to the RF transceiver and the micro-controller for a period of time provided by the timer circuit.

6. The device of claim 1 wherein a wakeup period is obtained for the time lapsed between the receipt of two consecutive wakeup signals.

7. The device of claim 6 wherein the period to decrement the histogram values is determined by the micro-controller using the wakeup period and provided by the timer circuit to the power management circuit.

8. The device of claim 7 wherein the wakeup period is obtained by using a counter to count the wake up pulses provided to the RF transceiver; and
the counter is returned to zero when it exceeds the period to decrement the histogram values.

9. The device of claim 1 wherein:
a plurality of count values is stored so that each count value corresponds to a range of signal strengths measured by the micro-controller;
each received wakeup signal is associated with the range of signal strengths, incrementing the count value associated with that range to create the histogram; and
the device responds to the wakeup signal by providing power to the RF transceiver and the micro-controller for a period of time.

10. The device of claim 1 wherein the RF transceiver is an ultra-high frequency (UHF) transceiver.

11. A system for avoiding over polling in wireless communications comprising a tag and a reader such that:
the reader transmits a wakeup signal periodically;
the tag receives the wakeup signal from the reader and measures a signal strength;
the system uses the signal strength to update a count value in a bin of a histogram;
the histogram values are decremented periodically; and
the tag responds to the wakeup signal if the count value in the histogram is lower than a threshold value.

12. A method for using a device comprising the steps of:
receiving a wakeup signal using an RF transceiver;
measuring the signal strength using a micro-controller;
using a signal strength to update a count value in a bin of a histogram;
decrementing the histogram values periodically; and
responding to the wakeup signal from the reader using the RF transceiver if the count value in the histogram is lower than a threshold value.

13. The method of claim 12 wherein:
the device also comprises a timer circuit and a power management circuit to deliver power coupled to the transceiver and the micro-controller; and
the micro-controller circuit regulates the power delivered by the power management circuit using the wakeup signal and a signal from the timer circuit.

14. The method of claim 13 further comprising the step of obtaining a wakeup period for the time lapsed between the receipt of two consecutive wakeup signals.

15. The method of claim 14 wherein the step of decrementing the histogram values is performed in a period determined by the micro-controller using the wakeup period, and provided by the timer circuit to the power management circuit.

16. The method of claim 14 wherein the step of obtaining a wakeup period is performed by using a counter to count the wakeup pulses received by the RF transceiver; and
the counter is returned to zero when it exceeds the period to decrement the histogram values.

17. The method of claim 12 wherein the RF transceiver is a UHF transceiver.

18. A method for avoiding over polling in wireless communications between a tag and a reader comprising the steps of:
sending wakeup signals periodically using the reader;
receiving the wakeup signal from the reader using the tag;
measuring a signal strength using the tag;
using the signal strength to update a count value in a bin of a histogram;
decrementing the histogram values periodically; and
responding to the wakeup signal from the reader using the tag if the count value in the histogram is lower than a threshold value.
